(19) United States
(12) Patent Application Publication
(10) Pub. No.: US 2021/0319368 A1
(43) Pub. Date: Oct. 14, 2021

(54) FAULT DIAGNOSIS FOR DIAGNOSIS TARGET SYSTEM

(71) Applicant: IHI Corporation, Tokyo (JP)

(72) Inventors: Yusuke MOTEGI, Tokyo (JP); Yukihiro KAWANO, Tokyo (JP); Hitomi NAGASHIMA, Tokyo (JP); Takumi KUSAKABE, Tokyo (JP)

(21) Appl. No.: 17/356,517

(22) Filed: Jun. 24, 2021

Related U.S. Application Data
(63) Continuation of application No. PCT/JP2018/048281, filed on Dec. 27, 2018.

(51) Int. Cl. G06N 20/00; G05B 15/02

(52) U.S. Cl. CPC G06N 20/00; G05B 15/02

(57) ABSTRACT

A fault diagnosis device includes circuitry configured to acquire diagnosis target data including parameter values from the diagnosis target system, to store extraction source data including a plurality of data sets that includes the parameter values of the diagnosis target data representing a normal state of the diagnosis target system, to determine an extraction condition based on the diagnosis target data and on condition setting information, to extract a group of data sets satisfying the extraction condition among the plurality of data sets, to select, as learning data, a number of first data sets of the group, in which the data sets of the group are sorted according to a sorting criterion, to generate learning information from the learning data, and to determine whether the diagnosis target data associated with the diagnosis target system is faulty based on the learning information.

### CROSS-REFERENCE TO RELATED APPLICATIONS

This application is a continuation application of PCT Application No. PCT/JP2018/048281, filed Dec. 27, 2018, the entire contents of which are incorporated herein by reference.

### BACKGROUND

Generally, in a machine system such as a plant where a plurality of devices operates, the state of the system is measured using a plurality of sensors, for example, and measured data is used to perform fault diagnosis such as the occurrence of a problem in machine system. Nowadays, for the purpose of highly accurately performing fault diagnosis in machine systems, analysis methods using pattern recognition techniques are studied.

For example, Japanese Unexamined Patent Publication No. 2017-102826 describes a fault diagnosis device for the purpose of performing fault diagnosis corresponding to a change in the status of a machine system in which a data set satisfying extraction condition is extracted as learning data from a plurality of data sets showing a state of the machine system in the past and fault diagnosis is performed based on learning information created from the learning data. In the fault diagnosis device, a parameter value included in diagnosis target data is combined with extraction condition information that determines the extraction condition for the learning data to determine the extraction condition for the learning data, and thus the learning data is dynamically selected suitable for the diagnosis target data.

### SUMMARY

An example fault diagnosis device disclosed herein is a device that performs fault diagnosis on a diagnosis target system. The fault diagnosis device includes circuitry that is configured to acquire diagnosis target data including parameter values from the diagnosis target system, to store extraction source data including a plurality of data sets that includes the parameter values of the diagnosis target data representing a normal state of the diagnosis target system, to determine an extraction condition based on the diagnosis target data and on condition setting information, to extract a group of data sets satisfying the extraction condition among the plurality of data sets of the extraction source data, to select, as learning data, a number of first data sets of the group, in which the data sets of the group are sorted according to a sorting criterion, to generate learning information from the learning data, and to determine whether the diagnosis target data is faulty based on the learning information.

### BRIEF DESCRIPTION OF DRAWINGS

FIG. 1 is a diagram illustrating the functional blocks of an example fault diagnosis device.

FIG. 2 is a flowchart illustrating a series of processes of a fault diagnosis method performed by the fault diagnosis device of FIG. 1.

FIG. 3 is a flowchart illustrating an update process for extraction source data performed by the fault diagnosis device of FIG. 1.

FIG. 4 is a diagram illustrating the configuration of a fault diagnosis program.

### DETAILED DESCRIPTION

Examples of fault diagnosis for a diagnosis target system will be described.

An example fault diagnosis device performs fault diagnosis on a diagnosis target system using a pattern recognition method. The example fault diagnosis device includes: an acquisition unit configured to acquire diagnosis target data including parameter values of a plurality of items from the diagnosis target system; a storage unit (e.g., a storage device) configured to store extraction source data including a plurality of data sets; an extraction unit configured to determine extraction condition using the diagnosis target data and condition setting information for determining the extraction condition to extract learning data from the extraction source data; a creation unit configured to create, from the learning data, learning information used for the pattern recognition method; and a diagnosis unit configured to determine whether the diagnosis target data is faulty based on the learning information. The plurality of data sets each includes the parameter values of the plurality of items when the diagnosis target system is a normal state. The extraction unit extracts, as the learning data, an upper limit number of data sets from a head when a group of data sets satisfying the extraction condition among the plurality of data sets included in the extraction source data is rearranged by a predetermined criterion.

An example fault diagnosis method is executed by a fault diagnosis device to perform fault diagnosis on a diagnosis target system using a pattern recognition method. The example fault diagnosis method includes: acquiring diagnosis target data including parameter values of a plurality of items from the diagnosis target system; determining extraction condition using the diagnosis target data and condition setting information for determining the extraction condition; extracting learning data from extraction source data including a plurality of data sets; creating, from the learning data, learning information used for the pattern recognition method; and determining whether the diagnosis target data is faulty based on the learning information. The plurality of data sets each includes the parameter values of the plurality of items when the diagnosis target system is a normal state. In the extracting step, among the plurality of data sets included in the extraction source data, an upper limit number of data sets from a head when a group of data sets satisfying the extraction condition is rearranged by a predetermined criterion are extracted as the learning data.

An example fault diagnosis program disclosed herein causes a computer to execute fault diagnosis on a diagnosis target system using a pattern recognition method. The example fault diagnosis program causes the computer to: acquire diagnosis target data including parameter values of a plurality of items from the diagnosis target system; determine extraction condition using the diagnosis target data and condition setting information for determining the extraction condition; extract learning data from extraction source data including a plurality of data sets; create, from the learning data, learning information used for the pattern recognition method; and determine whether the diagnosis target data is faulty based on the learning information. The plurality of data sets each includes the parameter values of the plurality of items when the diagnosis target system is a normal state. In the extracting of learning data, among the plurality of data sets included in the extraction source data, an upper limit number of data sets from a head when a group of data sets satisfying the extraction condition is rearranged by a predetermined criterion are extracted as the learning data.

An example recording medium disclosed herein is a computer-readable recording medium recording a fault diagnosis program for causing a computer to execute fault diagnosis on a diagnosis target system using a pattern recognition method. The fault diagnosis program causes the computer to execute the following: acquiring diagnosis target data including parameter values of a plurality of items from the diagnosis target system; determining extraction condition using the diagnosis target data and condition setting information for determining the extraction condition; extracting learning data from extraction source data including a plurality of data sets; creating, from the learning data, learning information used for the pattern recognition method; and determining whether the diagnosis target data is faulty based on the learning information. The plurality of data sets each includes the parameter values of the plurality of items when the diagnosis target system is a normal state. In the extracting step, among the plurality of data sets included in the extraction source data, an upper limit number of data sets from a head when a group of data sets satisfying the extraction condition is rearranged by a predetermined criterion are extracted as the learning data.

In the example fault diagnosis devices, fault diagnosis methods, fault diagnosis programs, and recording mediums described herein, the extraction condition is determined using the diagnosis target data and the condition setting information for determining the extraction condition, and among the plurality of data sets included in the extraction source data, an upper limit number of data sets from a head when a group of data sets satisfying the extraction condition is rearranged by a predetermined criterion, are extracted as the learning data. As described above, for the extraction of learning data, since the extraction condition determined using the diagnosis target data is used, the learning data that is suitable for fault diagnosis on the diagnosis target data is extracted, and learning information used for the pattern recognition method is created using this learning data. Therefore, even in the case in which the status of the diagnosis target system changes, fault diagnosis is performed using learning information suitable for the diagnosis target data. This makes it possible to perform fault diagnosis suitable for the status of the diagnosis target system. Since the data sets up to the upper limit number are extracted as the learning data, the number of data sets included in learning data is restricted to the upper limit number. Accordingly, the time to create learning information or the like may be reduced, so as to reduce the time necessary for diagnosis while fault diagnosis suitable for the status of the diagnosis target system is performed.

The example fault diagnosis device may further include an update unit configured to update the extraction source data stored in the storage unit (e.g., storage device). The update unit may add a normal data set to the extraction source data to update the extraction source data. In this case, the number of data sets included in the extraction source data increases, so as to increase the possibility that the number of data sets satisfying the extraction condition among the plurality of data sets included in the extraction source data is equal to or greater than the upper limit number. This makes it possible to suppress a decrease in the accuracy of fault diagnosis.

The criterion may be an order of temporal proximity to a time when diagnosis is performed on the diagnosis target data. The status of the diagnosis target system may change gradually with a lapse of time. When the plurality of data sets included in the extraction source data is old with respect to the time when diagnosis is performed, there is a risk of being diagnosed as faulty even though the diagnosis target data is normal. In contrast to this, when the data set close to the time when diagnosis is performed is used as the learning data, it is possible to suppress a decrease in the accuracy of fault diagnosis.

When the normal state of the diagnosis target system changes, the extraction unit may extract the learning data from a data set after the normal state of the diagnosis target system changes in the plurality of data sets included in the extraction source data. In this case, the data set before the normal state changes is excluded, and the learning data is extracted thereafter, so as to reduce time necessary to search for the data set satisfying the extraction condition.

In the following description, with reference to the drawings, the same reference numbers are assigned to the same components or to similar components having the same function, and overlapping description is omitted.

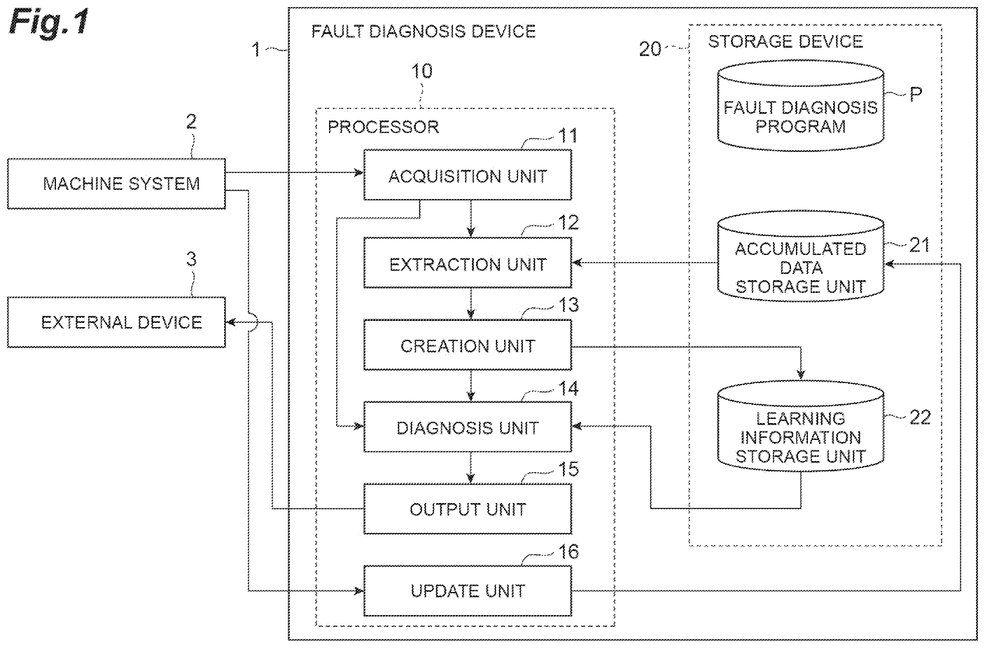

FIG. 1 is a diagram showing the functional blocks of an example fault diagnosis device 1. The example fault diagnosis device 1 shown in FIG. 1 is a device performing fault diagnosis on a machine system 2 using a pattern recognition method. The fault diagnosis device 1 is connected to the machine system 2 and to an external device 3 so as to allow communicating with each other. A pattern recognition method is a method that determines whether a pattern presented by diagnosis target data to be a target for fault diagnosis is normal based on the learning information formed by learning data. Examples of the pattern recognition method include the Mahalanobis-Taguchi Method (MT method), the Recognition-Taguchi Method (RT method), the variation pressure method (standardized variation pressure method), the reconstruction error method (RE method), Sparse Bayesian Learning (SBL), principal component analysis, multiple regression analysis, and logistic regression analysis (multivariate analysis). The pattern recognition method is not limited to these methods.

The machine system 2 is a system that is a target for diagnosis. Examples of the machine system 2 include machine systems, such as a gas turbine, aero-engine, and vacuum furnace. A plurality of sensors is attached or connected to the machine system 2 in order to check the operation status of the machine system 2. The machine system 2 transmits a data set including the parameter value of each of a plurality of items as diagnosis target data to the fault diagnosis device 1. The data set is also referred to as sample data.

Each item may be a value representing a feature of the machine system 2. Examples of such an item include control value, command value, and response value of a plurality of types of devices (a valve, a pump, and the like) included in the machine system 2 and sensor values detected by the plurality of sensors provided in the machine system 2. The number of items of the parameter value may be several hundreds or more, for example.

The sample data (data set) may include parameter values that change depending on the internal situation of the machine system 2 as well as parameter values that change depending on the external situation of the machine system 2. The parameter values that change depending on the external situation of the machine system 2 are values specified by an external device or the like, and values indicating information on external environments, and these values are different from values derived from control in the machine system 2. Examples of such parameter values include temperatures around the machine system 2, and output set values of a certain device. On the other hand, the parameter value that changes depending on the internal situation of the machine system 2 is the parameter value that changes depending on the operation of the machine system 2. Examples of such a parameter value include sensor values of the sensors provided in the machine system 2. For the fault diagnosis of the machine system 2, at least the parameter value that changes depending on the internal situation is used.

The external device 3 includes a display and the like, for example, and has a function of outputting diagnosed results by the fault diagnosis device 1.

The fault diagnosis device 1 is formed by circuitry that includes a processor 10 and a storage device 20.

The storage device 20 includes a data-readable and writable recording medium such as a random access memory (RAM), a semiconductor memory, and a hard disk drive. The storage device 20 includes an accumulated data storage unit 21 (storage unit), a learning information storage unit 22, and a fault diagnosis program P.

The accumulated data storage unit 21 stores extraction source data that is a group of data sets that may be used as learning data. The extraction source data includes a plurality of data sets. Each of the plurality of data sets corresponds to the sample data in the case in which the machine system 2 is in a normal state, and includes parameter values of a plurality of items in the normal state. Each of the plurality of data sets is sample data transmitted from the machine system 2 in the past. Each of the plurality of data sets includes time information indicating a time at which the data set is acquired and a status flag indicating whether the data set is normal or faulty, for example.

The extraction source data may include other data in addition to the sample data transmitted from the machine system 2. That is, the extraction source data may include data acquired from a machine system (e.g. a facility in the same system present in another site) different from the machine system 2 and simulation results under the specific environmental condition in a system that simulates the machine system 2, for example.

The learning information storage unit 22 temporarily holds learning information created (or generated) by a creation unit (or generating unit) 13, which is described further below. The learning information is information used for a pattern recognition method. In the fault diagnosis device 1, learning information is created every time when diagnosis target data, which is described further below, is acquired from the machine system 2. The learning information storage unit 22 temporarily holds learning information created for every fault diagnosis, and upon the end of a series of processes on fault diagnosis, the learning information storage unit 22 deletes learning information used for fault diagnosis.

Examples of the processor 10 include a central processing unit (CPU), a microcontroller, and a digital signal processor (DSP). The processor 10 may be a single processor or a multiprocessor (e.g., including multiple processor devices). The processor 10 includes functional units such as an acquisition unit 11, an extraction unit 12, a creation unit (or generation unit) 13, a diagnosis unit 14, an output unit 15, and an update unit 16. The processor 10 reads and executes the fault diagnosis program P stored in the storage device 20 to operate the acquisition unit 11, the extraction unit 12, the creation unit 13, the diagnosis unit 14, the output unit 15, and the update unit 16. An example configuration of the fault diagnosis program P is described further below.

The acquisition unit 11 acquires the diagnosis target data from the machine system 2. The acquisition unit 11 outputs the acquired diagnosis target data to the extraction unit 12 and the diagnosis unit 14.

The extraction unit 12 extracts learning data from extraction source data based on the diagnosis target data received from the acquisition unit 11 and condition setting information set in advance in the extraction unit 12. For example, the extraction unit 12 determines extraction condition for the learning data using the diagnosis target data and the condition setting information. The extraction unit 12 reads extraction source data stored in the accumulated data storage unit 21 from the accumulated data storage unit 21, and extracts learning data from the extraction source data based on the extraction condition. The extraction unit 12 outputs the extracted learning data to the creation unit 13.

A method for determining the extraction condition will be described. The condition setting information is information for determining the extraction condition for the learning data, and indicates the condition relating to one or more items included in the plurality of items forming the data set. Examples of the condition setting information include an item identifier (ID) capable of uniquely identifying an item and condition information indicating a condition for the parameter value of the item identified by the item ID. The extraction unit 12 acquires the parameter value of the item identified by the item ID included in the condition setting information from the diagnosis target data, and determines the extraction condition using the parameter value and the condition indicated by the condition information included in the condition setting information.

In some examples, it is assumed that the item identified by the item ID is “intake-air temperature” and the condition indicated by the condition information is “plus or minus two degrees”. In the case in which (the parameter value of) the intake-air temperature of the diagnosis target data is “20 degrees”, the extraction condition is set to require that “(the parameter value of) the intake-air temperature is 18 degrees or above and 22 degrees or below”. In some examples, it is assumed that the item identified by the item ID is “set output” and the condition indicated by the condition information is “plus or minus 1 megawatt (MW)”. In the case in which (the parameter value of) the output of the diagnosis target data is “10 MW”, the extraction condition is set to require that “(the parameter value of) the set output is 9 MW or above and 11 MW or below”.

As described above, the condition setting information is information that indicates a part in regard to the condition for determining the extraction condition, and is information that determines the extraction condition for learning data using the specific parameter value included in the diagnosis target data. The extraction condition may be set such that “the parameter value of parameter C is in a range of 10 to 30” with no use of the specific parameter value included in the diagnosis target data. However, since learning data is extracted with no consideration of the status of the diagnosis target data acquired from the machine system 2, learning information with low relevance with the diagnosis target data is created. Therefore, in the fault diagnosis device 1, a configuration is adopted in which the parameter value included in diagnosis target data and the condition setting information for determining the extraction condition for the learning data are combined to determine the extraction condition for the learning data.

In the condition setting information, an item that is capable of identifying the status of the machine system 2 is selected as the item for which the condition is set. Examples of the status include the operating mode of the machine system 2 (operating and nonoperating modes, for example), the environmental status of the machine system 2 due to seasons, and the like. By using the parameter values of such items for extracting learning data, a data set having a situation similar to that in which the machine system 2 is placed may be extracted from the extraction source data.

The condition setting information is set in advance by an operator of the fault diagnosis device 1, for example. The extraction unit 12 may hold a plurality of pieces of condition setting information. In this case, the extraction unit 12 may select condition setting information to be used for the extraction of learning data from a plurality of pieces of condition setting information suitable for the diagnosis target data. For example, the extraction unit 12 may select condition setting information to be used for the extraction of learning data corresponding to the acquisition time period of the diagnosis target data. The extraction unit 12 may select condition setting information to be used for the extraction of learning data according to the direction by the operator.

A method for extracting learning data will be described. The extraction unit 12 extracts a data set satisfying the extraction condition, among a plurality of data sets included in the extraction source data from extraction source data. The extraction unit 12 sorts (rearranges) a group of data sets satisfying the extraction condition according to a sort criterion (or sorting criterion) that is a predetermined criterion, and extracts a predetermined upper limit number (the upper limit value) of data sets from the head as learning data.

As the sort criterion, the order of temporal proximity to a reference time is used, for example. Examples of the reference time include time when the machine system 2 is diagnosed and time when the machine system 2 is shipped. In the case in which the reference time corresponds to a time when diagnosis is performed, the extraction unit 12 sorts a group of data sets satisfying the extraction condition in order of latest date (date and time) first (i.e., the order of temporal proximity to the time when diagnosis target data is diagnosed). In the case in which the reference time corresponds to a time when the machine system 2 is shipped, the extraction unit 12 sorts a group of data sets satisfying the extraction condition in chronological order of oldest date (date and time) first (i.e., the order from time when the machine system 2 is shipped).

As the sort criterion, the ascending order of difference from the reference value may be used. An example of the reference value includes the parameter value of a given item of a plurality of items included in the diagnosis target data. For example, the extraction unit 12 sorts a group of data sets satisfying the extraction condition, on the given item in the plurality of items, in ascending order of difference from the parameter value included in the diagnosis target data (the absolute value of the difference). The set output may be used as such an item, for example. The item indicating the external environment, such as an intake-air temperature may be selected. As the sort criterion, the ascending order of the fault level score may be used.

The upper limit number is a number that can sufficiently describe the statistic, and is a test statistic, for example. The diagnostic accuracy is improved as the number of extractions is larger. However, when the number of extractions is increased to some extent, the diagnostic accuracy changes less even though the number increases more. On the other hand, the larger the number of extractions, the longer processing time. Therefore, the upper limit number is set to about 1,000, for example. Among the plurality of data sets included in the extraction source data, the number of data sets satisfying the extraction condition may sometimes correspond to the upper limit number or less. In this case, the extraction unit 12 extracts all the data sets satisfying the extraction condition as the learning data.

The creation unit 13 creates learning information corresponding to the diagnosis target data from the learning data received from the extraction unit 12. In the case in which the fault diagnosis device 1 performs diagnosis using the MT method, learning information is information indicating a unit space (in the case of the MT method, the unit space is a Mahalanobis space) and information indicating the determination criterion for performing fault diagnosis. The creation unit 13 outputs the learning information to the learning information storage unit 22, and stores the learning information in the learning information storage unit 22.

In creating learning information, the creation unit 13 evaluates the reliability of the learning information. For example, in the case in which the number of extractions of learning data, which is extracted based on the diagnosis target data, is small, or in the case in which an extraction ratio, which is learning data to the total number of data sets included in the extraction source data, is small, there is a possibility that the diagnosis target data is a rare type (outside circumference) of data in the extraction source data or that diagnosis target data is acquired under the outside circumference different from the extraction source data. In such a case, since there is a possibility that learning information created based on the extracted learning data is not appropriate for the diagnosis target data, a possibility arises that the accuracy of fault diagnosis using learning information is degraded.

Therefore, the creation unit 13 evaluates whether the reliability of the learning information is high based on the number of extractions or the extraction ratio, for example. For example, the creation unit 13 compares the number of extractions with a preset lower limit value (a lower limit number) to determine a level of reliability of the learning information. The lower limit value is a value smaller than the upper limit number. For example, the creation unit 13 determines that the reliability of the learning information is high in the case in which the number of extractions is equal to or greater than the lower limit value, whereas the creation unit 13 determines that the reliability of the learning information is low in the case in which the number of extractions is less than the lower limit value.

The creation unit 13 may compare the extraction ratio with another preset lower limit value to determine whether the reliability of the learning information is high. For example, the creation unit 13 determines that the reliability of the learning information is high in the case in which the extraction ratio is equal to or greater than another lower limit value, whereas the creation unit 13 determines that the reliability of the learning information is low in the case in which the extraction ratio is less than another lower limit value.

In the case in which the creation unit 13 determines that the reliability of the learning information has a problem (the reliability is low), the fault diagnosis device 1 may terminate further processes not to perform fault diagnosis itself. In the case in which the creation unit 13 determines that there is a problem in the reliability of the learning information (the reliability is low), the fault diagnosis device 1 may perform further processes on fault diagnosis on the premise that an alert indicating a low reliability is issued. These processes may be combined.

The diagnosis unit 14 determines whether the diagnosis target data is faulty (i.e., whether the machine system 2 is faulty) based on the learning information created by the creation unit 13. For example, the diagnosis unit 14 reads the learning information from the learning information storage unit 22, and calculates, for the diagnosis target data acquired from the machine system 2, a numerical value (fault level score) or the like, which is necessary to diagnose sample data, based on the learning information. In the case in which the fault diagnosis device 1 performs diagnosis using the MT method, the diagnosis unit 14 calculates a Mahalanobis distance as a fault level score based on the diagnosis target data and the learning information.

The diagnosis unit 14 determines whether the diagnosis target data is faulty based on the calculated result. The diagnosis unit 14 determines whether the machine system 2 is faulty by, for example, comparing the fault level score with a preset diagnosis threshold. In the case in which the fault level score is larger than the diagnosis threshold, the diagnosis unit 14 determines that the machine system 2 (the diagnosis target data) is faulty. In the case in which the fault level score is equal to or less than the diagnosis threshold, the diagnosis unit 14 determines that the machine system 2 (the diagnosis target data) is normal. The diagnosis unit 14 outputs the diagnosed result indicating that the machine system 2 (the diagnosis target data) is normal or faulty to the output unit 15.

The output unit 15 outputs the diagnosed result received from the diagnosis unit 14. In some examples, the output unit 15 outputs the diagnosed result to the external device 3. The output unit 15 may output a combination of the diagnosed result from the diagnosis unit 14 and information relating to the learning information to the external device 3. The output unit 15 prepares the diagnosed result and the relating information in compliance with a predetermined output format, and outputs these pieces of information to the external device 3. The output unit 15 may output the diagnosis target data together with the diagnosed result to the update unit 16.

The update unit 16 updates the extraction source data stored in the accumulated data storage unit 21. The update unit 16 acquires one or more normal data sets and updates the extraction source data by adding the normal data sets to the extraction source data. The update unit 16 may acquire, as a normal data set, a data set inputted to the fault diagnosis device 1 by the operator of the fault diagnosis device 1 using an input device, for example. A configuration may be provided in which the update unit 16 sequentially acquires a plurality of data sets from the machine system 2, including a normal data set, which is a data set among the plurality of data sets, to which a status flag indicating normality is assigned.

For example, the operator of the fault diagnosis device 1 inputs a period (a normal period) in which the machine system 2 is normal to the fault diagnosis device 1 using the input device. The update unit 16 sets the status flag indicating normality to the data set acquired in the normal period of the machine system 2 among the plurality of data sets inputted to the fault diagnosis device 1. The update unit 16 may set a status flag corresponding to the diagnosed result by the diagnosis unit 14.

The update unit 16 updates the extraction source data at an update timing. The update timing is a timing at which the occurrence of a certain event is detected. Examples of certain events include the completion of the maintenance of the machine system 2, a lapse of a certain time period from the previous update of the extraction source data, the fault level scores of a series of a predetermined number of pieces of diagnosis target data being larger than the diagnosis threshold, and an input of an update instruction to the fault diagnosis device 1 by the operator using the input device. In other words, the extraction source data may be automatically updated, or manually updated.

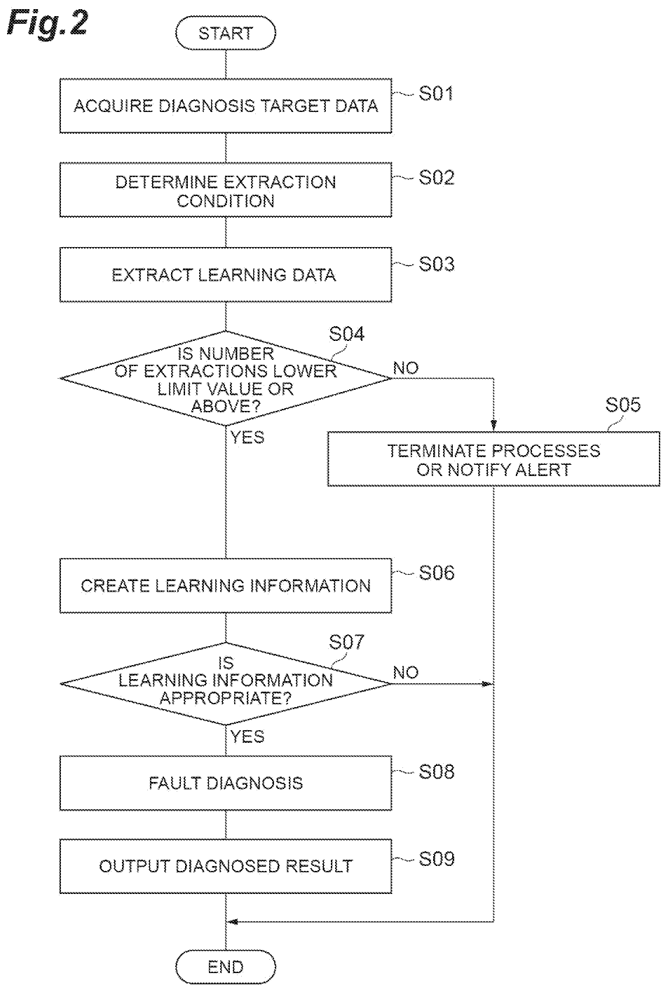

Referring now to FIG. 2, a fault diagnosis method performed by the fault diagnosis device 1 will be described. FIG. 2 is a flowchart showing a series of processes of the fault diagnosis method performed by the fault diagnosis device in FIG. 1. The series of processes shown in FIG. 2 may be performed each time diagnosis target data is obtained in the machine system 2, for example.

First, the acquisition unit 11 acquires diagnosis target data from the machine system 2 (Step S01). The acquisition unit 11 then outputs the acquired diagnosis target data to the extraction unit 12 and the diagnosis unit 14.

Subsequently, upon receiving the diagnosis target data from the acquisition unit 11, the extraction unit 12 selects condition setting information corresponding to the diagnosis target data from the plurality of pieces of held condition setting information. The extraction unit 12 then determines extraction condition for the learning data using the diagnosis target data and the condition setting information (Step S02).

Subsequently, the extraction unit 12 reads extraction source data stored in the accumulated data storage unit 21 from the accumulated data storage unit 21, and extracts learning data from the extraction source data based on the extraction condition (Step S03). In some examples, the extraction unit 12 extracts a data set satisfying the extraction condition among a plurality of data sets included in the extraction source data from the extraction source data. The extraction unit 12 then sorts (rearranges) a group of data sets satisfying the extraction condition according to the sort criterion, and extracts the upper limit number of data sets from the head as learning data. The extraction unit 12 then outputs the extracted learning data to the creation unit 13.

Subsequently, upon receiving the learning data from the extraction unit 12, the creation unit 13 determines whether the number of data sets extracted as learning data is equal to or greater than the lower limit value for the purpose of evaluating the reliability of the learning information (Step S04). In the case in which the creation unit 13 determines that the number of extracted data sets is less than the lower limit value (Step S04: NO), the creation unit 13 determines that the reliability is low even though learning information is created, and the creation unit 13 terminates further processes or generates an alert (Step S05). The series of processes of the fault diagnosis method performed by the fault diagnosis device 1 is then ended.

On the other hand, in Step S04, in the case in which the creation unit 13 determines that the number of extracted data sets is equal to or greater than the lower limit value (Step S04: YES), the creation unit 13 creates learning information corresponding to the diagnosis target data from the learning data (Step S06). Additionally, the creation unit 13 may continue fault diagnosis after generating an alert in Step S05. In this case, similarly to the case in which the creation unit 13 determines that the number of extracted data sets is equal to or greater than the lower limit value (Step S04: YES), the creation unit 13 creates the learning information (Step S06).

Subsequently, the creation unit 13 determines whether the created learning information is appropriate (Step S07). For example, in the case in which data sets used as learning data are extremely biased due to inappropriate extraction condition despite a sufficient number of the extracted data sets, the learning information may be determined to be inappropriate. The creation unit 13 has a preset determination criterion whether learning information is appropriate. The creation unit 13 determines whether the learning information is appropriate based on the determination criterion. In the case in which the creation unit 13 determines that the learning information is not appropriate (Step S07: NO), the creation unit 13 terminates further processes. A series of processes of the fault diagnosis method performed by the fault diagnosis device 1 is then ended.

On the other hand, in step S07, when the creation unit 13 determines that the learning information is appropriate (step S07; YES), the creation unit 13 outputs the learning information to the learning information storage unit 22 and stores the learning information in the learning information storage unit 22. After storing the learning information in the learning information storage unit 22, the creation unit 13 notifies the diagnosis unit 14 that the creating process for the learning information is ended. Additionally, the creation unit 13 notifies the diagnosis unit 14 that creating learning information is terminated also in the case in which creating learning information is terminated.

Subsequently, upon receiving the notification that the creating process for learning information is ended from the creation unit 13, the diagnosis unit 14 performs fault diagnosis of the diagnosis target data based on the learning information (Step S08). For example, the diagnosis unit 14 reads the learning information from the learning information storage unit 22, and calculates a fault level score or the like using the diagnosis target data and the learning information. The diagnosis unit 14 then determines whether the diagnosis target data is faulty based on the calculated result (the fault level score). The diagnosis unit 14 then outputs the diagnosed result indicating that the diagnosis target data is normal or faulty to the output unit 15.

Subsequently, upon receiving the diagnosed result from the diagnosis unit 14, the output unit 15 outputs the diagnosed result (Step S09). In some examples, the output unit 15 applies selective processing to the diagnosed result, and then outputs the diagnosed result to the external device 3. At this time, the output unit 15 may delete learning information stored in the learning information storage unit 22. The output unit 15 may output the diagnosis target data together with the diagnosed result to the update unit 16. In the case in which creating the learning information is terminated, fault diagnosis itself is not performed. Thus, the diagnosis unit 14 outputs a diagnosed result indicating that fault diagnosis is terminated to the output unit 15, and the output unit 15 notifies the external device 3 or the like that fault diagnosis is not performed. As described above, the series of processes of the fault diagnosis method performed by the fault diagnosis device 1 is ended.

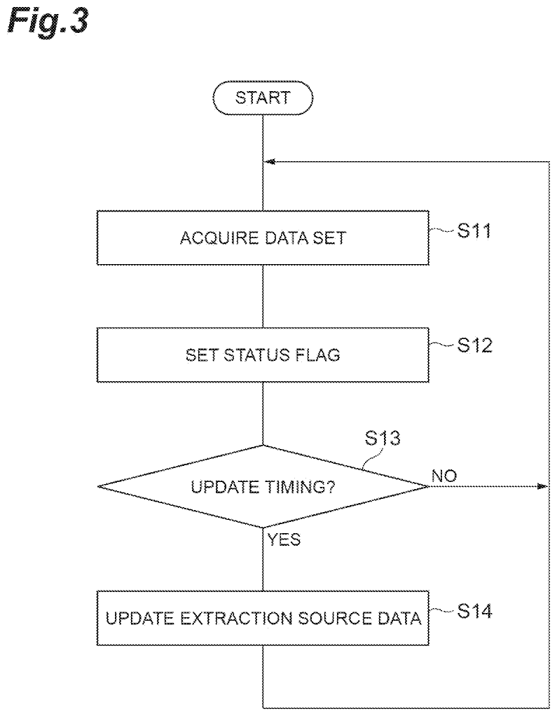

Referring now to FIG. 3, an update process for the extraction source data will be described. FIG. 3 is a flowchart showing the update process for extraction source data performed by the fault diagnosis device in FIG. 1. A series of processes shown in FIG. 3 is started, for example, when a data set is transmitted from the machine system 2.

First, the update unit 16 acquires a data set (Step S11). The update unit 16 sequentially acquires a plurality of data sets from the machine system 2, for example. The update unit 16 then sets a status flag to each of the plurality of acquired data sets (Step S12). For example, the operator of the fault diagnosis device 1 inputs a normal period of the machine system 2 to the fault diagnosis device 1 using the input device. The update unit 16 sets the status flag indicating normality to the data set obtained in the normal period of the machine system 2 among the plurality of data sets inputted to the fault diagnosis device 1. The update unit 16 may set a status flag corresponding to the diagnosed result by the diagnosis unit 14.

Subsequently, the update unit 16 determines whether the update timing has been reached (Step S13). In the case in which a specific event such as the maintenance of the machine system 2 occurs, the update unit 16 determines that the update timing has been reached (Step S13: YES). The update unit 16 then updates the extraction source data (Step S14). For example, the update unit 16 acquires, as a normal data set, the data set to which a status flag indicating normality is assigned among the plurality of data sets acquired in Step S11, and updates the extraction source data by adding the normal data set to the extraction source data. The update unit 16 then performs the series of processes again.

On the other hand, in the case in which the update unit 16 determines that the update timing has not been reached in Step S13 (Step S13: NO), the update unit 16 again performs the series of processes without updating the extraction source data.

As described above, since a data set to which a status flag indicating normality is assigned is added to the extraction source data at every update timing, the number of data sets included in the extraction source data is increased.

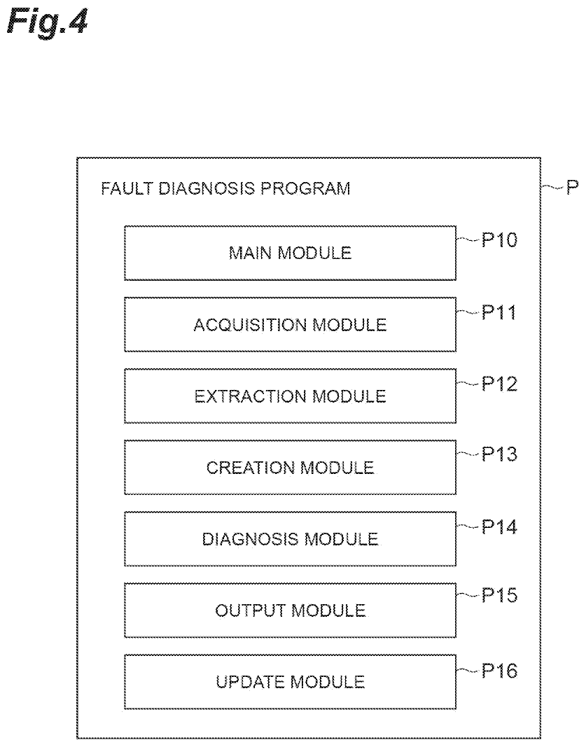

Next, referring to FIG. 4, the fault diagnosis program P for causing a computer to function as the fault diagnosis device 1 will be described. FIG. 4 is a diagram showing the configuration of the fault diagnosis program.

As shown in FIG. 4, the fault diagnosis program P includes a main module P10, an acquisition module P11, an extraction module P12, a creation module P13, a diagnosis module P14, an output module P15, and an update module P16. The main module P10 is a section comprehensively controlling processes on fault diagnosis. The functions achieved by executing the acquisition module P11, the extraction module P12, the creation module P13, the diagnosis module P14, the output module P15, and the update module P16 are the same as the functions of the acquisition unit 11, the extraction unit 12, the creation unit 13, the diagnosis unit 14, the output unit 15, and the update unit 16 of the above-described example.

The fault diagnosis program P may be provided in a state in which the fault diagnosis program P is fixedly recorded on a tangible recording medium such as a compact disk read only memory (CD-ROM), digital versatile disk read only memory (DVD-ROM), and a semiconductor memory. The fault diagnosis program P may be provided as data signals superposed on carrier waves via a communication network.

Next, the operation and effect of the example fault diagnosis device 1, fault diagnosis method, fault diagnosis program P, and recording medium will be described.

Since the status of the machine system 2 may vary due to the maintenance, seasons, the operating modes of the machine system 2, and the like, even a single machine system 2 may be in various normal states. For example, in a configuration in which a data set in a certain period is used as learning data to create learning information for performing fault diagnosis on the machine system 2, learning information is created from a data set acquired in one normal state of the machine system 2 to perform fault diagnosis on the machine system 2. Therefore, there is a possibility that so-called erroneous detection, in which the diagnosis target data acquired in another normal state of the machine system 2 is diagnosed as a fault, may occur. On the other hand, it is also considered that the range of a certain period is extended to create learning information using data sets acquired in a plurality of normal states of the machine system 2. In this case, there is a possibility that so-called non-detection, in which the diagnosis target data acquired from the machine system 2 in a faulty state is diagnosed as normal, may occur. In order to reduce erroneous detection and non-detection, it is also considered that learning information is separately created for every status (normal state) of the machine system 2. However, the status of the machine system 2 sometimes continuously changes, and it is difficult to cluster a plurality of data sets into pieces of learning data corresponding to each status.

In contrast to this, in the example fault diagnosis device 1, fault diagnosis method, fault diagnosis program P, and recording medium, the diagnosis target data and the condition setting information for determining the extraction condition are used to determine the extraction condition, the upper limit number of data sets from the head are extracted as the learning data in the case in which a group of data sets satisfying the extraction condition among a plurality of data sets included in the extraction source data is rearranged according to the sort criterion. For the extraction of learning data, since the extraction condition determined using the diagnosis target data is used, the learning data suited to fault diagnosis on the diagnosis target data is extracted, and learning information used for the pattern recognition method is created by this learning data. Therefore, even in the case in which the status of the machine system 2 changes, fault diagnosis is performed using learning information suitable for the diagnosis target data. This makes it possible to reduce a possibility that erroneous detection and non-detection occur. In other words, it is possible to perform fault diagnosis suitable for the status of the machine system 2. Since the learning information is created to be suitable for the diagnosis target data, the learning information is dynamically created every time when diagnosis is performed. Therefore, it is unnecessary to create in advance, learning information corresponding to the entire status of the machine system 2.

Since the data sets up to the upper limit number are extracted as the learning data, the number of data sets included in learning data is restricted to the upper limit number. Therefore, it is possible to reduce the time necessary to create learning information, for example. Consequently, it is possible to reduce the time necessary for the fault diagnosis while performing the fault diagnosis suitable for the status of the machine system 2.

Additionally, in the case in which the number of data sets satisfying the extraction condition among the plurality of data sets included in the extraction source data is less than the upper limit number, the number of data sets included in the learning data is reduced, and thus there is a possibility that the accuracy of fault diagnosis is reduced. In contrast to this, in the fault diagnosis device 1, the fault diagnosis method, the fault diagnosis program P, and the recording medium, the extraction source data is updated by adding the normal data set to the extraction source data. Therefore, since the number of data sets included in the extraction source data is increased, it is possible to increase a possibility that the number of data sets satisfying the extraction condition among the plurality of data sets included in the extraction source data is equal to or greater than the upper limit number. This makes it possible to increase the accuracy of fault diagnosis.

The status of the machine system 2 may change gradually over a period of time. Therefore, in the case in which the plurality of data sets included in the extraction source data is old with relative to the time when diagnosis has been performed, there is a risk that the diagnosis target data is diagnosed as faulty even though the diagnosis target data is normal. In contrast to this, in the case in which the order temporal proximity to a time when diagnosis is performed on the diagnosis target data is used as the sort criterion, a data set in closer temporal proximity to the time when diagnosis has been performed, is used as the learning data. This makes it possible to suppress degradation in the accuracy of fault diagnosis. Since a new data set is added to the extraction source data, it is possible to suppress degradation in the accuracy of fault diagnosis.

The extraction source data may be automatically updated in the fault diagnosis device 1. In this case, since the load of update work can be reduced, it is possible to maintain the accuracy of the fault diagnosis while reducing operation costs of the fault diagnosis device 1.

In the case in which the order of temporal proximity to a time when the machine system 2 is shipped is used as the sort criterion, it is possible to diagnose degradation from the time when the machine system 2 is shipped. In the case in which the ascending order of the fault level score is used as the sort criterion, the fault diagnosis is performed using the data sets that are likely to be normal. This makes it possible to further improve the accuracy of fault diagnosis.

It is to be understood that not all aspects, advantages and features described herein may necessarily be achieved by, or included in, any one particular example. Indeed, having described and illustrated various examples herein, it should be apparent that other examples may be modified in arrangement and detail.

In some examples, the fault diagnosis device 1 is provided by a single device. In other examples, the fault diagnosis device 1 may include a plurality of devices.

Instead of the processor 10, an application specific integrated circuit (ASIC), a programmable logic device (PLD), a field programmable gate array (FPGA), or the like may be used.

The sections of the functional blocks shown in FIG. 1 are an example. The fault diagnosis device 1 may be sectioned into other functional blocks corresponding to the functions. The functional units of the fault diagnosis device 1 may be sectioned into smaller parts. Alternatively, some functional units may be coupled into one functional unit.

As the number of data sets included in the extraction source data increases, it takes more time to search for a data set satisfying the extraction condition. Therefore, a configuration may be provided in which the accumulated data storage unit 21 rearranges a plurality of data sets included in the extraction source data according to the sort criterion, splits the rearranged data sets into a plurality of tables for every predetermined number of data sets from the data set at the head of the arrangement, and holds the extraction source data. Here, the tables are referred to as the first table, the second table, and so on in the order of arrangement.

In this case, the extraction unit 12 selects the table one by one from the first table in the plurality of tables, and extracts a data set satisfying the extraction condition from the plurality of data sets included in the selected table. At this time, in the case in which the number of extracted data sets does not reach the upper limit number, the extraction unit 12 selects the subsequent table, and extracts a data set satisfying the extraction condition from a plurality of data sets included in the selected table. The processes are repeated until the number of extracted data sets reaches the upper limit number, or until all the tables are selected. According to this configuration, it is possible to reduce the time necessary to search for the data set satisfying the extraction condition.

The normal state of the machine system 2 may change due to external factors. For example, in the case in which the maintenance of the machine system 2 is performed, the normal state of the machine system 2 may change. An example of the maintenance of the machine system 2 includes the replacement of a sensor provided on the machine system 2. Therefore, the data sets stored in the extraction source data may further include a change flag indicating whether the data set is a data set before the normal state changes or a data set after the normal state changes. The change flag indicates that the data set is a data set after the normal state changes in default. The following configuration may be provided. In the case in which the maintenance of the machine system 2 is performed, the update unit 16 sets the change flag of a data set having time information indicating the time before the time at which the maintenance is completed such that the change flag indicates the data set before the normal state changes. The extraction unit 12 then may extract learning data from the data set after the normal state changes among a plurality of data sets included in the extraction source data with reference to the change flag. Alternatively, the update unit 16 may update the extraction source data by deleting the data set before the normal state changes from extraction source data.

According to this configuration, the data set before the normal state changes is excluded, and then the learning data is extracted. This makes it possible to reduce the time necessary to search for the data set satisfying the extraction condition. By deleting the data set before the normal state changes from the extraction source data, the number of data sets held in the accumulated data storage unit 21 can be reduced, and the capacity of the accumulated data storage unit 21 can be reduced.

A configuration may be provided in which the status flag of the data set stored in the accumulated data storage unit 21 is changeable by the operator of the fault diagnosis device 1 using the input device. For example, a configuration may be provided in which the status flag is changed to indicate being faulty in the case in which erroneous detection is determined.

The extraction unit 12 may relax the extraction condition so that the number of data sets satisfying the extraction condition is equal to or greater than the upper limit number in the case in which the number of data sets satisfying the extraction condition among the plurality of data sets included in the extraction source data does not reach the upper limit number. For example, in the case in which the extraction condition is set to require that “(the parameter value of) the intake-air temperature is 18 degrees or above and 22 degrees or below” and the number of data sets satisfying the extraction condition does not reach the upper limit number, the extraction unit 12 may change the extraction condition to the extraction condition according to which “(the parameter value of) the intake-air temperature is 17 degrees or above and 23 degrees or below”. In other words, the extraction unit 12 may extend the range of the extraction condition. Accordingly, this enables the number of data sets included in learning data to be the upper limit number, so as to suppress degradation in the accuracy of fault diagnosis.

In the case in which the number of data sets satisfying the extraction condition does not reach the upper limit number in the plurality of data sets included in the extraction source data, the following processes may be performed. First, the extraction unit 12 extracts the data set with a wider extraction range. The creation unit 13 then estimates the value of the determination target sensor and the valiance thereof by performing methods such as simple regression and multiple regression using the extracted data set. The diagnosis unit 14 then calculates the fault level score (Mahalanobis distance) using the estimated value and valiance of the sensor as the learning information.

In some examples, the extraction unit 12 extracts a group of data sets satisfying the extraction condition from the plurality of data sets included in the extraction source data, sorts the group of data sets according to the sort criterion, and extracts the upper limit number of data sets from the head of the sorted group of data sets as the learning data. The method for extracting learning data is not limited to this method.

For example, in the case in which the number of data sets satisfying the extraction condition is the upper limit number or less in the plurality of data sets included in the extraction source data, the extraction unit 12 may extract the data set satisfying the extraction condition as learning data without sorting.

The extraction unit 12 may sort the plurality of data sets included in the extraction source data according to the sort criterion and then determine whether the plurality of sorted data sets satisfies the extraction condition in the order from the head of the sorted data sets. In this case, when the number of data sets satisfying the extraction condition reaches the upper limit number, the extraction unit 12 extracts the upper limit number of data sets as learning data.

1. A fault diagnosis device for a diagnosis target system, the fault diagnosis device comprising circuitry configured to:
acquire diagnosis target data including parameter values from the diagnosis target system;
store in a storage device, extraction source data including a plurality of data sets, wherein each of the plurality of data sets includes the parameter values of the diagnosis target data representing a normal state of the diagnosis target system;
determine an extraction condition based on the diagnosis target data and on condition setting information;
extract a group of data sets satisfying the extraction condition, among the plurality of data sets of the extraction source data;
select, as learning data, a number of first data sets of the group, wherein the data sets of the group are sorted according to a sorting criterion;
generate learning information from the learning data; and
determine whether the diagnosis target data associated with the diagnosis target system is faulty based on the learning information.

2. The fault diagnosis device according to claim 1, wherein the circuitry is further configured to update the extraction source data stored in the storage device, by adding a normal data set to the extraction source data.

3. The fault diagnosis device according to claim 2, wherein the extraction source data is updated at a timing when a maintenance of the diagnosis target system is completed.

4. The fault diagnosis device according to claim 2, wherein the extraction source data is updated when a certain time period has elapsed since a previous update of the extraction source data.

5. The fault diagnosis device according to claim 2, wherein the circuitry is further configured to calculate a fault level score of the diagnosis target data based on the learning information,
wherein whether the diagnosis target data is faulty is determined based on the fault level score, and
wherein the extraction source data is updated when fault level scores of a series of a predetermined number of pieces of diagnosis target data is greater than a diagnosis threshold.

6. The fault diagnosis device according to claim 2, wherein the circuitry is further configured to acquire, as the normal data set, a data set obtained when the diagnosis target system is in a normal state.

7. The fault diagnosis device according to claim 1, wherein the sorting criterion indicates an order of temporal proximity to a time when diagnosis is performed on the diagnosis target data.

8. The fault diagnosis device according to claim 1, wherein when the normal state of the diagnosis target system changes, the learning data is extracted from data sets after the normal state of the diagnosis target system changes, among the plurality of data sets included in the extraction source data.

9. The fault diagnosis device according to claim 1, wherein the parameter values are associated with a plurality of items of the diagnosis target system, and wherein the condition setting information indicates a condition relating to one or more items of the plurality of items.

10. The fault diagnosis device according to claim 1, wherein the condition setting information is selected to correspond to a time period when the diagnosis target data is acquired.

11. The fault diagnosis device according to claim 1, wherein the number of data sets to be selected from the group corresponds to an upper limit number, and
wherein when a number of data sets to be extracted in the group does not reach the upper limit number, the extraction condition is modified so that the number of data sets extracted in the group reaches the upper limit number.

12. The fault diagnosis device according to claim 1, wherein the learning information includes information indicating a unit space and information indicating a determination criterion for performing fault diagnosis.

13. The fault diagnosis device according to claim 1, wherein the circuitry is further configured to evaluate a reliability of the learning information.

14. The fault diagnosis device according to claim 13, wherein the learning information is evaluated as not reliable when a number of data sets extracted to form the learning data is less than a lower limit value.

15. The fault diagnosis device according to claim 14, wherein determining whether the diagnosis target data is faulty is performed when the learning information is evaluated as reliable.

16. The fault diagnosis device according to claim 14, wherein the circuitry is further configured to generate an alert when the learning information is evaluated as not reliable.

17. The fault diagnosis device according to claim 1, wherein the circuitry is further configured to calculate a fault level score of the diagnosis target data based on the learning information, and wherein whether the diagnosis target data is faulty is determined based on the fault level score.

18. A fault diagnosis method for a diagnosis target system, the fault diagnosis method comprising:
acquiring diagnosis target data including parameter values from the diagnosis target system;
storing extraction source data including a plurality of data sets, wherein the plurality of data sets includes the parameter values of the diagnosis target data representing a normal state of the diagnosis target system;
determining an extraction condition based on the diagnosis target data and on condition setting information;
extracting a group of data sets satisfying the extraction condition, among the plurality of data sets of the extraction source data;
selecting, as learning data, a number of first data sets of the group, wherein the data sets of the group are sorted according to a sorting criterion;
generating learning information from the learning data; and
determining whether the diagnosis target data associated with the diagnosis target system, is faulty based on the learning information.

19. A non-transitory computer-readable storage device storing processor-executable instructions to cause a processor to:
acquire diagnosis target data including parameter values from a diagnosis target system;
store in a storage device, extraction source data including a plurality of data sets, wherein the plurality of data sets includes the parameter values of the diagnosis target data representing a normal state of the diagnosis target system;
determine an extraction condition based on the diagnosis target data and on condition setting information;
extract a group of data sets satisfying the extraction condition, among the plurality of data sets of the extraction source data;
select, as learning data, a number of first data sets of the group, wherein the data sets of the group are sorted according to a sorting criterion;
generate learning information from the learning data; and
determine whether the diagnosis target data associated with the diagnosis target system is faulty based on the learning information.

20. The computer-readable storage device according to claim 19, further comprising instructions to cause the processor to:
acquire, as a normal data set, a data set obtained when the diagnosis target system is in a normal state; and
update the extraction source data in the storage device, by adding the normal data set to the extraction source data.
